(19) United States
(12) Patent Application Publication
(10) Pub. No.: US 2007/0262695 A1
(43) Pub. Date: Nov. 15, 2007

(54) UV and near visible lamp filter

(76) Inventors: Juliana P. Reisman, Beachwood, OH (US); Paul G. Hlahol, Mentor, OH (US); Lisa M. Ward, Northfield, OH (US); Robert R. Gallucci, Mount Vernon, IN (US)

Correspondence Address: FAY SHARPE LLP, 1100 SUPERIOR AVENUE, SEVENTH FLOOR, CLEVELAND, OH, 44114, US

(21) Appl. No.: 11/432,043

(22) Filed: May 11, 2006

(51) Int. Cl. H01J 63/04; H01J 1/62

(52) U.S. Cl. 313/485

(57) ABSTRACT

A lamp (10) includes an envelope (12) and a source of illumination (22, 24, 26) disposed within the envelope. The source (22, 24, 26) emits radiation at least in the ultraviolet and visible regions of the spectrum. A film (30) is disposed around the envelope to block the transmission of substantially all light emitted from the envelope in the UV range and below a selected wavelength in the visible range, the selected wavelength being above about 450 nm. The film transmits substantially all visible light above the selected wavelength. The film includes a polymer matrix and a blocking material dispersed in the polymer matrix. The polymer matrix and blocking material are stable at lamp operating temperatures of above 100° C.

### BACKGROUND OF THE INVENTION

The invention is directed to a light source comprising a filter which effectively blocks ultraviolet (UV) transmission from a lamp while providing a high transmission of light in a selected visible range of the electromagnetic spectrum. It finds particular application in processing environments where unwanted ultraviolet light is deleterious to the process, such as in the manufacture of semiconductor components.

Most light sources, such as fluorescent lamps, emit light throughout the UV and visible range of the electromagnetic spectrum. Ultraviolet is generally considered to encompass the range of 100 to 400 nanometers, with the visible range extending from about 400 to 700 or 750 nanometers. Most fluorescent lighting has a high output in the UVA range (320-400 nanometers) as well as strong emission in the near visible (blue) portion of the visible range (400-500 nanometers).

There are a variety of applications in which light in the ultraviolet range is to be avoided or carefully controlled, such as in processes where UV-curable polymers are employed. For example, in lithography processes, a photoresist comprising a photosensitive resin is used to pattern a silicon wafer. A sensitizer in the photoresist is designed to react to light at a specific wavelength. The unwanted photoresist is selectively removed in a controlled fashion. Accidental exposure to ambient light tends to result in manufacturing defects.

Conventionally, filters have been placed in front of lamps to screen out the UV. However, such filters do not always completely seal the lamps, leading to leakage of the UV. Additionally, they tend to block a significant portion of the light in the visible range as well, so that the lumen output is significantly diminished. Lamp manufacturers have recently developed fluorescent lamps, such as T8 and T12 lamps, which are fitted with a sleeve of a polymer, such as polycarbonate or polyethylene, incorporating a UV filter material. Sleeves have also been formed of polyethylene terephthalate to which a thin film of gold is applied. Such lamps are capable of blocking UV and blue light. However, the lamps tend to be quite dim due to the blockage of a significant proportion of the visible light.

Other designs have used a powdered pigment deposited on the inside glass bulb wall to block the undesirable rays. Such coatings tend to have low light output and UV leaking through coating defects. Many applications would benefit from a light source which effectively blocks UV radiation while providing a high lumen output in the visible range.

### BRIEF DESCRIPTION OF THE INVENTION

In accordance with one aspect of the exemplary embodiment, a lamp is provided. The lamp includes an envelope. A source of illumination is disposed within the envelope, the source emitting radiation at least in the ultraviolet and visible regions of the spectrum. A film is disposed around the envelope which blocks the transmission of substantially all light emitted from the envelope in the UV range and below a selected wavelength in the visible range. The selected wavelength is above about 450 nm. The film transmits substantially all visible light above the selected wavelength. The film includes a polymer matrix and a blocking material dispersed in the polymer matrix. The polymer matrix and blocking material are UV stable at lamp operating temperatures of above 100° C.

In accordance with another aspect of the exemplary embodiment, a lamp is provided. The lamp includes an envelope. A sleeve surrounds the envelope, the sleeve comprising a polymer matrix which includes a polyetherimide as a dominant component and a blocking material dispersed in the polymer matrix, the blocking material comprising a coumarin dye.

In accordance with another aspect, a method of forming a lamp includes providing a source of illumination disposed within an envelope and disposing a film around the envelope so as to block the transmission of substantially all light emitted from the envelope in the range of 300 to 400 nm and below a selected wavelength in the visible range. The selected wavelength is above about 450 nm. The film transmits substantially all visible light above the selected wavelength. The film includes a polymer matrix and a blocking material dispersed in the polymer matrix. The polymer matrix and blocking material are UV stable at lamp operating temperatures of above 100° C.

### BRIEF DESCRIPTION OF THE DRAWINGS

FIG. 1 is a schematic side sectional view of a lamp according to one aspect of the exemplary embodiment;

FIG. 2 is an enlarged side sectional view of the wall of the lamp of FIG. 1;

FIG. 3 shows plots of irradiance and transmittance in the range of 300 to 750 nm for: (A) an exemplary lamp without filter; (B) a film formed of an exemplary polymer matrix (polyetherimide) without a blocking material; (C) a lamp with the sleeve of (B); (D) a film formed of an exemplary polymer matrix with an exemplary blocking material (coumarin-7 dye); (E) a lamp with the sleeve of (D); and

FIG. 4 is a plot of irradiance and transmittance in the range of 200 to 800 nm for: (E) a lamp with the sleeve of (D).

### DETAILED DESCRIPTION OF THE INVENTION

Aspects of the exemplary embodiment relate to a light source which includes a lamp, such as a fluorescent lamp, and a filter, which may be in the form of a film, e.g., as a coating or sleeve, which blocks the transmission of substantially all light in the UV range and transmits substantially all visible light above a selected wavelength λ, which may be in the near visible range, such as about 480 nanometers. The filter comprises a polymeric material which is stable at high temperatures and which filters at least a portion of the UV light. A blocking material, which may be a colorant that is dispersed in the polymeric material, provides a filter which blocks substantially all residual UV light and which provides a cut-on at about the selected wavelength. The exemplary filter provides significantly more visible light output than conventional systems while still blocking the unwanted UV and near visible wavelengths.

By substantially all light in the UV range, it is meant that the filter blocks the transmission of at least 95% of all incident UV light from about 245-400 nanometers, and in one embodiment, blocks at least 99% of the incident UV light such that less than 1% of the light output of the lamp below 400 nanometers passes through the filter. The filter may also block the transmission of at least 95%, e.g., at least 99%, of incident light in the range of 400 nanometers up to the selected wavelength λ, whereby less than 5%, e.g., less than 1%, of the output of the lamp in this range is transmitted through the filter. By transmission of substantially all visible light above the selected wavelength, it is meant that the filter transmits at least 70% of the incident light in the range between λ and at least about 650 nanometers, e.g., up to about 700 nanometers. For purposes of describing the exemplary embodiment, the visible range is considered to extend from 400 to 700 nm, unless otherwise noted.

For purposes of determining transmission (and also blocking) values of the filter, a broadband light source may be used for illumination of the filter, such a 1000 W/120V FEL lamp. FEL is an ANSI designation. This particular quartz tungsten halogen lamp is a lamp standard used to calibrate spectral irradiance from 250 nm to 2500 nm. For example, percentage transmission in a range between two wavelengths, such as 530 to 700 nm, can be determined by calculating a cumulative sum of irradiance over the specified range for the broadband source with the filter, then dividing by the cumulative sum over the same range of the broadband source without the filter. The cumulative sum may be obtained, for example, by integrating under the curve, e.g., by summing the transmission values at every wavelength in the range.

In one embodiment, the filter has a sharp cut-on (at the selected wavelength), e.g., spanning a wavelength range of about 50 nm or less, over which range the transmission (at a given wavelength) increases from less than about 5% to greater than about 80%. This ensures that as little of the useful light as possible is wasted. The filter may block the light in the UV and/or near visible range by absorption and/or by conversion of the light to light of longer wavelengths.

The selected wavelength λ may be at least about 450 nanometers, and may be up to about 600 nanometers, e.g., about 550 nanometers or less, depending on the application. For example, specific UV curable resins are sensitive to light at specific wavelengths. The value of λ may be selected to be above the maximum wavelength to which the resin is sensitive. In one embodiment, λ may be for example, at least 460 nm, and in one embodiment, at least 470 nm, e.g. about 480 nm.

In various aspects, the film has a UV transmission (e.g., in the range of 300 to 400 nm) of less than about 1% (i.e., less than about 1% of all UV light in the range of 300 to 400 nm that is incident on the sleeve is transmitted), e.g., less than 0.1%. In one embodiment, less than about 1% of all UV light in the range of 245 to 400 nm that is incident on the sleeve is transmitted. The film may have a visible light transmission in a range of 500-700 nm of greater than about 70%, e.g., at least 80% (i.e. at least about 70% or at least about 80% of all incident light in the 500-700 nm range is transmitted). In one embodiment, the film (and hence the sleeve formed therefrom) has a visible light transmission in a range of 530-700 nm of at least about 85%.

The exemplary light source finds application in semiconductor processing for curing UV-curable resins as well as in the illumination of clean rooms, hospitals, pharmaceutical processing facilities, blood processing and storage facilities, museums and other artifact storage facilities, and in other applications where ultraviolet and near visible light is unwanted.

It has now been found that when exposed to high temperatures, conventional plastic filters often do not have the capability to hold their shape, resulting in distortion or cracking which may allow unwanted UV light to pass through. Additionally, the blocking material may lose its blocking capacity over time. In various aspects, the exemplary filter is employed with a lamp which has an operating temperature in excess of 100° C. over at least a portion of the lamp that is touching or closely adjacent the filter (typically the hottest portion of the glass, which is closest to the electrode). The lamp operating temperature may be up to about 170° C., over extended periods, and up to about 200° C., for shorter periods, without deleteriously affecting the filter. By comparison, conventional filters are only stable up to a temperature of 70°-80° C., making them unsuited to use in close proximity to high power/small diameter lamps.

The exemplary filter is particularly advantageous for use with T5 fluorescent lamps, which have a high lumen output. Because of the small diameter (the T value represents the diameter in ⅛^{th} inches, i.e., T5 lamps have a nominal diameter of ⅝ inches) these lamps have a high surface temperature. However, they tend to have a higher energy efficiency than T12 lamps and are also more compact, allowing a larger number of lamps to be fitted into a smaller area than conventional larger diameter lamps. However, its use is not limited to small diameter fluorescent lamps but may find application in T8 and T12 lamps, for example, as well as with incandescent lamps. An exemplary lamp is a lamp with a high lumen output, such as a F54T5/HO lamp.

In various aspects, the filter may be in the form of a sleeve which surrounds the lamp so that at least 90% and in one embodiment, at least 95% or at least 99% of all light emitted by the lamp is subjected to filtering by the sleeve. In general, small amounts of unfiltered light may be emitted through vent holes in the base of the lamp. These emissions can be shielded by a housing which supports the lamp.

The filter may comprise a film including a polymeric material in which a colorant (pigment or dye) is finely, e.g., molecularly dispersed. The colorant, in combination with the polymeric material serves as a UV and near visible filter. The polymeric material and colorant can be selected to operate over the life of the lamp while maintaining the UV and near visible blocking properties under high heat conditions. The colorant may be selected to filter the undesirable wavelengths while maximizing the visible light output of the lamp in regions of the spectrum outside the undesirable wavelengths. The polymeric material may be selected to have broad UV filtering capabilities so that the colorant need filter only in a relatively narrow band in the near visible range.

The exemplary filter may employ a polymeric matrix material which is UV stable at temperatures in excess of 100° C., generally above 150° C., as well as a blocking material which is stable at such temperatures. By UV stable, it is meant that the filter retains its UV and visible blocking properties substantially unchanged for extended periods, e.g., for at least 2000 hours, and generally for the useful lifetime of the lamp, which may be about 20,000 hours or more. For example, a filter which, when first used, blocks at least 99% of radiation from the lamp that is in the range of 300-480 nm, continues to block over 98% and generally over 99% throughout the useful life of the lamp.

In addition to UV stable, the blocking material is one which is melt stable, i.e., stable at the processing temperature utilized for forming the filter. For example, in the case of polyetherimide, extrusion temperatures may be about 350° C. for several minutes. In general, the blocking material does not appreciably decompose, change color, or degrade the matrix material under such processing conditions. Additionally, the filter is generally shape stable, i.e., resistant to cracking and distortion under the lamp operating conditions, over the useful lifetime of the lamp.

In various aspects, the polymeric matrix may comprise a polyetherimide (which can include one or more different polyetherimides) and the blocking material may comprise a coumarin-based dye (which can include one or more different coumarin-based dyes).

The optical density of a filter to a range of radiation is directly related to the concentration of the blocking material and thickness of the layer. The thinner the layer, the higher the concentration of blocking material which is generally required. Very thin blocking layers, e.g., below 10 micrometers, may require high levels of the blocking material and thus may be difficult to compound. The thickness of the film may be from about 25 to about 500 micrometers. In one embodiment, the film has a thickness of at least about 100 micrometers. In another embodiment, the film has a thickness of less than about 250 micrometers, e.g., about 200 micrometers.

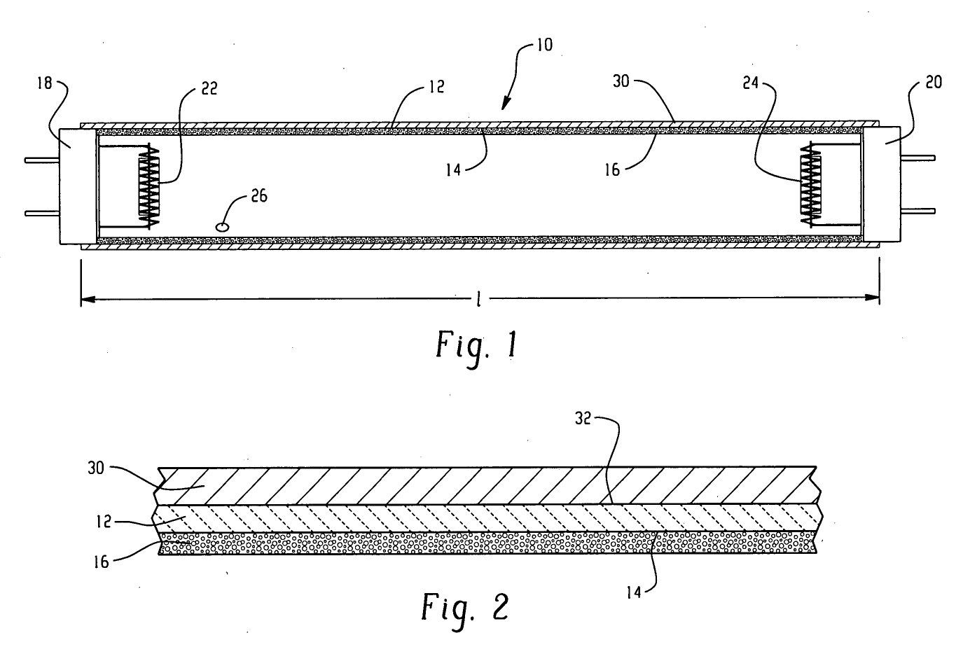

FIG. 1 shows a representative low pressure mercury vapor discharge fluorescent lamp 10. It will be appreciated that a variety of fluorescent lamps may be used, including single or double ended lamps, and curved or straight lamps. The fluorescent lamp 10 has a light-transmissive tube or envelope 12 formed from glass, quartz, or other suitable vitreous material. The illustrated envelope has a circular cross-section, although other configurations are contemplated. The envelope 12 may be substantially transmissive to all light in the UV and visible range of the spectrum. As best shown in FIG. 2, an inner surface 14 of the envelope 12 is provided with a phosphor-containing layer or layers 16.

The lamp 10 is hermetically sealed by bases 18, 20, attached at ends of the tube, respectively (FIG. 1), which may be formed from metal. Two spaced electrodes 22, 24 are respectively mounted on the bases 18, 20 for interconnection with a source of electric power (not shown). Each electrode may comprise a coil which is coated by an emitter material. A discharge-sustaining fill, preferably formed from mercury 26 and an inert gas, is sealed inside the glass tube 12, to be excited by the electrodes during lamp operation. The inert gas is typically argon or a mixture of argon and other noble gases at low pressure, which, in combination with a small quantity of mercury, provide a low vapor pressure during lamp operation. The lamp can be a low pressure mercury vapor discharge lamp, as described; however, a high pressure mercury vapor discharge lamp is also contemplated.

The phosphor-containing layer or layers 16 typically contain phosphor particles which are known in the art, such as a relatively inexpensive “halo” phosphor which emit a white light, such as a calcium halophosphate activated with antimony and manganese. Rare earth phosphor systems may also be used. These phosphor systems are typically a blend of rare earth phosphors, such as a mixture of red, blue, and green color-emitting phosphors. In one embodiment, the phosphor is a blend which is selected to provide a lamp with a color temperature of about 3000K to provide maximum lumen output with minimal near UV-blue emission.

A sleeve 30 surrounds the envelope. The sleeve 30 comprises a filter in the form of a film formed according to the exemplary embodiment. The illustrated sleeve 30 is entirely comprised of the film (i.e., a single layer of film). However, it is also contemplated that the sleeve 30 may comprise multiple film layers, one or more of which may be a filter formed according to the exemplary embodiment. The illustrated sleeve has a length l which exceeds a length of the envelope 12, such that all light transmitted by the envelope is filtered by the sleeve. In the illustrated embodiment, the sleeve extends to at least partially cover the bases 18, 20. For example, about 50% to about 70%, or more of the base may be covered with the filter. The sleeve 30 may be constricted, in the region of the bases, to provide a tight seal which substantially eliminates light emission in the longitudinal direction. Additionally or alternatively, the filter may be adhesively attached to the bases 18, 20. The exemplary film 30 is in direct contact with an outer surface 32 of the lamp envelope or closely spaced therefrom solely by an air gap (i.e., free of any adhesive layer therebetween).

During operation, a ballast (not shown) provides a high voltage pulse across the electrodes 22, 24, which causes breakdown of the fill to initiate an arc. In the case of a high output lamp 10, the power applied to the lamp during continuous operation may be in excess of 50 watts, such as about 54 watts for a high output T5 lamp. Such a lamp may have a lumen output, in the absence of the filter, in excess of 4000 lumens, such as about 4460 lumens (measured at 25° C.). In the presence of the sleeve 30, the lumen output of the lamp may be at least about 85% or at least 90% of the lamp without the sleeve, and in one embodiment, at least about 94%, e.g., about 4200 lumens.

The filter 30 may comprise an extruded tube comprising a polymeric matrix in which the blocking material -is dispersed. An exemplary filter may be formed by compounding the matrix material with the blocking material at a suitable processing temperature sufficient to melt the matrix material and optionally also the blocking material. For example, the compounding may be performed according to the methods described in U.S. Pat. No. 6,355,723 to vanBaal, et al., e.g., by melt blending techniques in a vacuum vented single or twin screw extruder with a good mixing screw operating at a temperature which is about 100° C. to about 150° C. higher than the Tg of the matrix material. The compounded mixture may be formed into pellets or other comminuted form for later extrusion as a sleeve or may be directly formed into a sleeve.

The polymer sleeve can be made by melt processing a suitable thermoplastic mixture. Melt processing may be performed with or without a suitable solvent, such as an organic solvent in which the polymer matrix and dye are soluble. Processes that do not use a solvent may be employed to reduce chemical emissions. For example, the polymer sleeve can be melt extruded by first drying the polymer to remove any absorbed water, e.g., dried for about 4 hr at 150° C., melting the polymer, and then using a screw pumping device to force the molten polymer through a die to make the polymer sleeve. In other instances, the thermoplastic polymer can be melt extruded, or blown into a film from which a sleeve can be fashioned. Other methods of fabricating the UV absorbing thermoplastic sleeve are also contemplated.

The Polymer Matrix

Exemplary matrix materials for the filter 30 include, as a dominant component (i.e., at least 50, 60, 70, 75, 80, 85, 90, 95, 96, 97, 98, 99 or 100 weight percent), at least one polymer which is stable at temperatures in excess of 100° C. and generally in excess of 150° C. Useful high temperature polymeric matrices include as a dominant component a polymer having one or more of the following moieties: imide, ether, amide, fluoroalkyl, epoxy, carbonate, and ester. Exemplary high temperature polymeric matrix polymers polyetherimides, polyimides, polyesters, polyesteramides, polyesteramideimides, polyamides, polyamideimides, high temperature polycarbonates, polyethers, polyetherketones, polyphthalamides, epoxy resins, fluoroethyl polymers, and the like, including derivatives and combinations thereof. Suitable polymers having such a high temperature stability and which also provide UV blocking and which are melt processable include polyetherimides and blends of polyetherimide with compatible polymers which retain good light transmission in the 500-700 nm range. The polyetherimide may be an impact-modified polyetherimide.

Thermoplastic (melt processable) polyetherimides have the general formula (1):

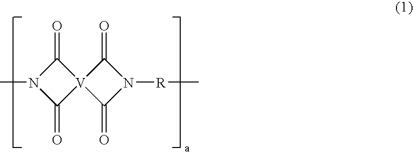

wherein a is more than 1, typically about 10 to about 1,000 or more, or more specifically about 10 to about 500; and wherein V is a tetravalent linker having at least one ether group. Suitable linkers include but are not limited to: (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations comprising at least one of the foregoing. At least a portion of the linkers V contain a portion derived from a bisphenol. Desirably linkers include but are not limited to tetravalent aromatic radicals of the structure (2)

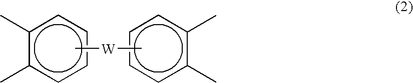

wherein W is a divalent moiety including an ether linkage —O—, or a group of the formula —O-Z-O— wherein the divalent bonds of the —O— or the —O-Z-O— group are in the 3,3′, 3,4′, 4,3′, or the 4,4′ positions, and wherein Z includes, but is not limited to divalent radicals of the formulas (3):

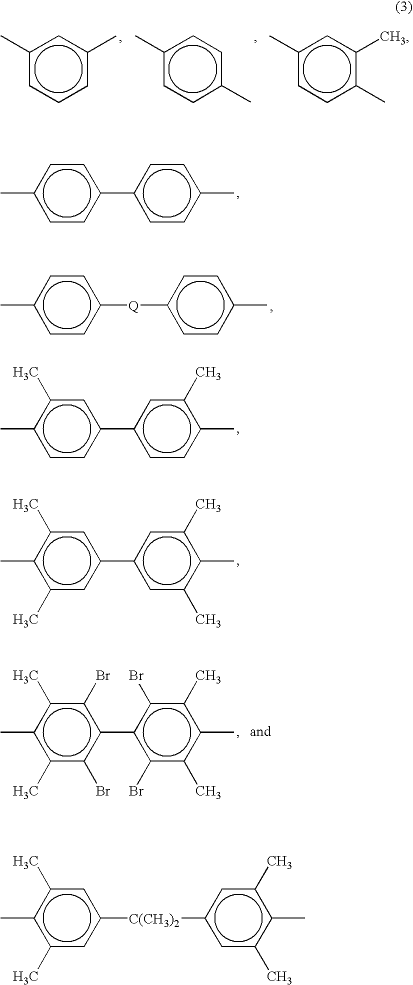

wherein Q includes but is not limited to a divalent moiety including —O—, —S—, —C(O)—, —SO₂—, —SO—, —C_{y}H_{2y}— (y being an integer from 1 to 30), and halogenated derivatives thereof, including perfluoroalkylene groups.

R in formula (3) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (4)

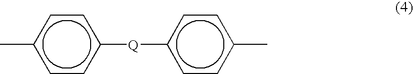

wherein Q includes but is not limited to a divalent moiety including —O—, —S—, —C(O)—, —SO₂—, —SO—, —C_{y}H_{2y}— (y being an integer from 1 to 30), and halogenated derivatives thereof, including perfluoroalkylene groups.

Exemplary polyetherimides are those which are melt processable, such as those whose preparation and properties are described in U.S. Pat. Nos. 3,803,085 and 3,905,942, and in the following published applications to Gallucci, et al.: 20040260055, published Dec. 23, 2004, 20050048299, published Mar. 3, 2005, and 20060078751, published Apr. 13, 2006. Polyetherimides combine the high temperature characteristics of polyimides but still have sufficient melt processability to be easily formed by conventional molding techniques such as compression molding, gas assist molding, profile extrusion, thermoforming and injection molding.

Exemplary polyetherimide resins comprise more than 1, typically about 10 to about 1,000, or more specifically, about 10 to about 500 structural units, of the formula (5)

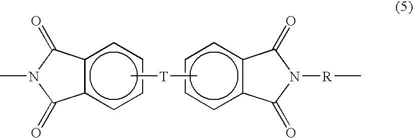

wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula 3 as defined above.

In one embodiment, the polyetherimide may be a copolymer which, in addition to the etherimide units described above, further contains polyimide structural units of the formula (6)

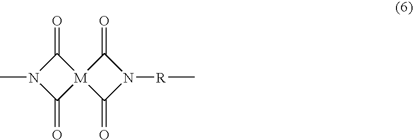

wherein R is as previously defined for formula (1) and M includes, but is not limited to, radicals of formulas (7).

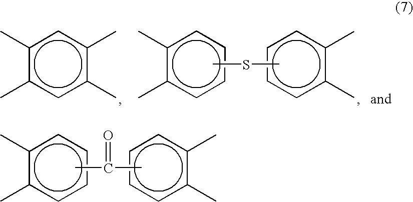

In one embodiment, the polyetherimide resin comprises structural units according to formula (4) wherein each R is independently p-phenylene or m-phenylene or a mixture comprising at least one of the foregoing and T is a divalent radical of the formula (8)

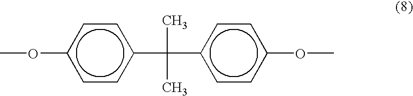

Included among the many methods of making the polyimides, particularly polyetherimides, are those disclosed in U.S. Pat. Nos. 3,847,867, 3,850,885, 3,852,242, 3,855,178, 3,983,093, and 4,443,591. The polyetherimide can be prepared for example, by the reaction of an aromatic bis(ether anhydride) of the formula (9)

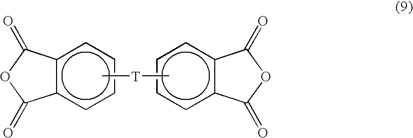

with an organic diamine of the formula (10)
H₂N—R—NH₂ (10)

wherein R and T are defined in relation to formulas (1) and (4).

Examples of specific aromatic bis(ether anhydride)s and organic diamines are disclosed, for example, in U.S. Pat. Nos. 3,972,902 and 4,455,410. The polyetherimide resins can optionally be prepared from reaction of an aromatic bis(ether anhydride) with an organic diamine in which the diamine is present in the reaction mixture at less than or equal to about 0.2 molar excess. Under such conditions the polyetherimide resin may have less than or equal to about 15 micro-equivalents per gram (μeq/g) acid titratable groups, or, more specifically less than or equal about 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin. When polyetherimide/polyimide copolymers are employed, a dianhydride, such as pyromellitic anhydride, is used in combination with the bis(ether anhydride).

Polyetherimides may also be synthesized by the reaction of the bis(halophthalimide) with an alkali metal salt of a bisphenol such as bisphenol A or a combination of an alkali metal salt of a bisphenol and an alkali metal salt of another dihydroxy substituted aromatic hydrocarbon in the presence or absence of phase transfer catalyst. Suitable phase transfer catalysts are disclosed in U.S. Pat. No. 5,229,482.

Generally, useful polyetherimide resins have a melt flow rate of about 1.0 to about 200 grams per ten minutes (“g/10 min”), as measured by American Society for Testing Materials (“ASTM”) D1238 at 337° C., using a 6.6 kilogram (“kg”) weight.

The polyetherimide resin may have a weight average molecular weight (Mw), expressed in grams per mole (“g/mole”), as measured by ASTM method D5296, of from about 10,000 to about 150,000, e.g., 20,000-60,000. ASTM D5205-96 provides a Standard Classification System for Polyetherimide (PEI) Materials. Exemplary polyetherimides comprise less than 5 mole % of sulfone containing linkages, e.g., less than 1 mole % of sulfone containing linkages. By 5 mole % sulfone linkages it is meant that in a polyetherimide, less than 5% of the repeating units that comprise the polyetherimide will contain an aryl sulfone (—Ar—SO2-Ar—) functional group. An exemplary sulfone is diamino diphenyl sulfone (DDS).

Aryl sulfone groups tend to cause photo yellowing during exposure to UV, which can change the filtering properties of the sleeve. Sulfone groups can be determined by standard chemical methods, for instance infrared spectroscopy. Exemplary polyetherimides may comprise less than 1000 ppm of halogen for ensuring environmental compatibility. The polyetherimides may have a glass transition temperature (Tg) as measured by ASTM method D3418 of from 200-280° C. and may have an intrinsic viscosity greater than about 0.2 deciliters per gram (“dl/g”), preferably about 0.35 to about 0.7 dl/g measured in m-cresol at 25° C.

Some such polyetherimides include, but are not limited to ULTEM® 1000 (weight average molecular weight (Mw) of about 38,000, Tg about 220° C.); ULTEM® 1010 (Mw about 33,000, Tg about 220° C.); ULTEM 5001 (Mw about 38,000, Tg about 227° C.; ULTEM 5011 Mw about 32,000 and Tg about 225° C.); and/or mixtures comprising at least one of the foregoing polyetherimides. Such polyetherimides may be obtained from GE Plastics. The matrix material may thus contain, as a dominant component, at least one polyetherimide.

The Blocking Material

The blocking material may comprise one or more color converting colorants. The colorant may be present as a dye or as a pigment. Dyes are colorants that do not normally scatter light but absorb light at some visible wavelength. Dyes are often soluble, at some concentration, in the polymer matrix. Pigments are organic or inorganic colorants that are usually present in a matrix as discrete particles insoluble in the matrix. The designation of a given colorant as pigment or dye will depend on the polymer matrix, colorant concentration and crystallinity, temperature, and other factors. In general, dyes have advantages for most applications in that they do not tend to cause appreciable scattering of the light.

Suitable colorants are those having a chemical structure such that the colorant does not escape in substantial amounts from the polymer mixture during melt processing at a temperature of from about 250° C. to 350° C. (in the case of a polyetherimide polymer matrix). Additionally, the colorant is generally one which does not chemically decompose or is substantially altered in its UV absorbing capability by exposure to the melt processing temperature. Furthermore the colorant generally does not cause degradation of the polymer matrix during high temperature processing, For example, after melt processing, the mixture of polymer and blocking material may retain at least about 70 percent of the initial molecular weight of the polymer prior to melt processing. Additionally, the blocking material may retain at least about 70 percent of its original, non-melt processed, optical properties after melt processing and extruding.

Color-converting colorants that absorb light in the blue to blue/green region and emit green (or red) light include, for example, coumarin type colorants such as 3-(2′-benzothiazolyl)-7-diethylaminocoumarin (Coumarin 6), 3-(2′-benzoimidazolyl)-7-diethylaminocoumarin (Coumarin 7), 3-(2′-N-methylbenzoimidazolyl)-7-diethylaminocoumarin (Coumarin 30) and 2,3,5,6-1H,4H-tetrahydro-8-trifluoromethylquinolizino-(9,9a,1-gh)coumarin (Coumarin 153), and Basic Yellow 51, which is a coumarin colorant type dye, and also naphthalimide type colorants such as Solvent Yellow 11 and Solvent Yellow 116, and combinations thereof. Other suitable colorants include Macrolex Yellow 6G Sol Y 179; Macrolex Yellow E2R; Macrolex Yellow RN (the Macrolex dyes are obtainable from LANXESS—Leverkusen, Germany); Solvent Yellow 93 and Solvent Yellow 33 (obtainable from Dynasty Chemicals Co, LTD—China); and Solvent Yellow 167 (obtainable from Advanced Technology & Industrial Co., Ltd.—Hong Kong). Some of the above colorants may benefit from the additional presence of a UV absorber.

Exemplary colorants suitable as blocking materials for the present application include coumarin based colorants with a weight loss at 300° C., as measured by ASTM method E1131 of less than 20%. The coumarin-based colorant may have a molecular weight Mw above 300. This helps to ensure that the colorant is retained in the polymer matrix during melt processing. In one embodiment, the coumarin-based colorant has a melting point below the Tg of the matrix material. For example, in the case of Ultem® 1000 and similar polyetherimides, which have a Tg of about 220° C., the melting point of the colorant may be about 219° C., or less, e.g., about 215° C. or less.

Coumarin 7, CAS No. 27425-55-4, is particularly suitable as a predominant matrix material for the exemplary sleeve 30 as it has a sharp transmission cut-on point at about 480-500 nm. It is a yellow dye with a molecular weight of 333 and a melting point of 214° C. It is stable at temperatures above 285° C. When combined with a polyetherimide, coumarin 7 produces a filter which filters substantially all UV and has a sharp absorption cut-off at 480 nm, with maximum (88%) transmission at 530 nm and above.

The colorant may be present in the sleeve at a concentration of from about 0.01-15%, e.g., 0.1-10%. The optimum concentration will depend to some degree on the thickness of the sleeve. For example, for a sleeve about 5-20 mils in thickness (0.127-0.508 mm), the concentration of the colorant may be about 0.4 wt %.

An exemplary sleeve is formed from a film which is made of a mixture comprising a blend of from 99.9 to 90 wt % polyetherimide with a total of 0.1-10 wt % of one or more coumarin dyes.

The lumen loss of a lamp with a sleeve formed according to the exemplary embodiment versus an un-sleeved lamp can be determined as:

$$\frac{Lamp lumen output without sleeve - Lamp lumen output with sleeve}{Lamp lumen output without sleeve}$$

The lumen loss of a lamp with a sleeve formed according to the exemplary embodiment versus an un-sleeved lamp is generally less than 15%, e.g., ranges from about 4-15%, depending on blocking material formulation and a tube thickness ranging between 0.125 and 0.250 mm. In one embodiment, the lumen loss is less than 10% and in another embodiment, is about 5%, or less. By contrast, a sleeve formed of polycarbonate or polyethylene with a UV blocking colorant may have a higher lumen loss (e.g., about 20-30%).

In various aspects of the exemplary embodiment, a method of illuminating an object includes forming a lamp with a filter according to the methods described herein, and operating the lamp, including applying an electric current to the lamp, and illuminating the object with light from the lamp, wherein less than 1% of light emitted has a wavelength of less than 480 nm. The object may be, for example, a blood sample, a museum artifact, or a semiconductor device comprising a photosensitive resin which is to be cured by light other than from the lamp.

Without intending to limit the scope of the exemplary embodiment, the following example demonstrates the effectiveness of a sleeve formed according to the exemplary embodiment.

### EXAMPLE

A sleeve 8 mils in thickness (0.20 mm) was formed by extruding pellets formed of a mixture of polyetherimide (Ultem® 1000) and 0.4% by weight of a coumarin dye (coumarin 7 obtained from Keystone Aniline Corp. under the tradename Keyplast Fluorescent Yellow 10G). The extrusion was performed by heating pellets comprising the polyetherimide and coumarin dye at a temperature of 355° C. to 371° C. for about 20 minutes to melt the pellets (using three barrel zones and a die temperature). These temperatures are similar to the temperatures that may be used to compound the polyetherimide with coumarin dye to form the pellets. It will be appreciated that the pellet-forming step may be eliminated by proceeding directly from compounding to extrusion.

The sleeve was formed such that there was minimal but sufficient clearance to apply over the glass tube of a lamp (an F54T5/HO/830 lamp) having a power consumption of 54 W and a lumen output at 25° C. of 4460. Lumens were measured according to IESNA Standard LM-9-99. The sleeve was cut to a length such that it covered the glass tube and overlapped approximately 50% to 75% of the length of each base on either end of the lamp. The sleeve was attached to the bases by shrink sealing according to the method of Sica, U.S. Pat. Nos. 5,729,085 and 5,536,998. Specifically, rings formed of polyolefin were placed over the sleeve in the region of the bases and shrunk by application of heat to conform the sleeve to the base. Thereafter, the residue of the ring was removed. The sleeve blocked greater than 99% of radiation in the spectral region 300-480 nm (measured as >99.99% with an Optronic Laboratories OL 756 Portable High-Accuracy UV-Visible Spectroradiometer on ten samples)). Percentage transmission in the following ranges were obtained, as follows:

| Spectral range | % Transmission |
|---|---|
| 245-400 nm | 0.011% |
| 400-480 nm | 0.002% |
| 500-700 nm | 85% |
| 530-700 nm | 86% |

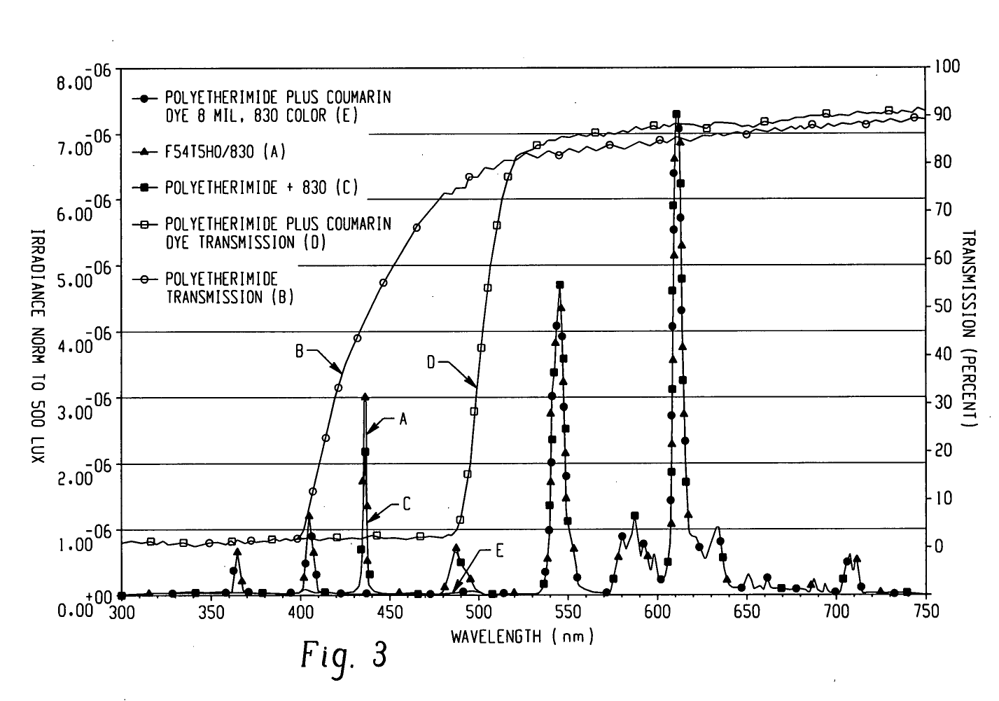

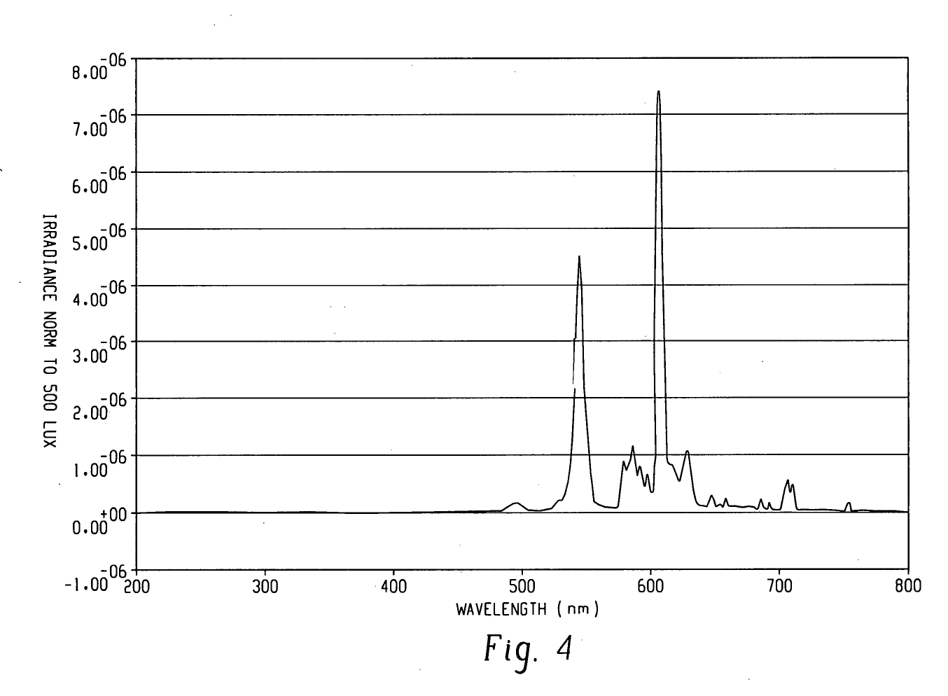

FIG. 3 illustrates spectra for irradiance in W/cm², for each nm increment (normalized to 500 Lux) for the lamp without a sleeve and corresponding percent transmission values for the sleeve without lamp in the range of 300 to 750 nm. The irradiance of the lamp without a sleeve (graph A) shows peaks in the ultraviolet and near visible range at around 365, 405, 436 and 490 nm, the first three of which may be deleterious for semiconductor processing applications. The transmission of a sleeve comprising Ultem®1000 alone (graph B) shows a cut on at about 400 nm. When combined with the lamp, the Ultem®1000 sleeve filters out the peaks at 365 and 405 (irradiance graph C), but transmits a significant proportion of the light at 435 and 490 nm. The exemplary sleeve, comprising Ultem® 1000 and coumarin-7 (graph D) is seen to shift the cut on transmission to around 500 nm (compare with graph B). When combined with the exemplary lamp (graph E), best shown in FIG. 4, the benefits of the sleeve are clearly apparent. Below, 500 nm, only a very small irradiance peak at about 490 nm is visible with virtually all (about 99% or higher) of the irradiance of the lamp and sleeve combination occurring above 500 nm.

The lamp and sleeve had a lumen output of 4260, i.e., a lumen loss only of about 4.5%, as compared with the un-sleeved lamp.

All cited patents and other references are incorporated herein by reference.

The invention has been described with reference to the preferred embodiment. Obviously, modifications and alterations will occur to others upon reading and understanding the preceding detailed description. It is intended that the invention be construed as including all such modifications and alterations.

What is claimed is:

1. A lamp comprising:
an envelope;
a source of illumination disposed within the envelope, the source emitting radiation at least in the ultraviolet and visible regions of the spectrum; and
a film disposed around the envelope which blocks the transmission of substantially all light emitted from the envelope in the UV range and below a selected wavelength in the visible range, the selected wavelength being above about 450 nm, and which transmits substantially all visible light above the selected wavelength,
the film comprising a polymer matrix and a blocking material dispersed in the polymer matrix, the polymer matrix and blocking material being UV stable at lamp operating temperatures of above 100° C.

2. The lamp of claim 1, wherein the selected wavelength is about 480 nm.

3. The lamp of claim 1, wherein the blocking material comprises a coumarin based colorant.

4. The lamp of claim 3, wherein the coumarin-based colorant exhibits a weight loss, measured at 300° C., of less than 20%.

5. The lamp of claim 1, wherein the polymer matrix comprises a melt-processable polymer.

6. The lamp of claim 1, wherein the polymer matrix comprises a polyetherimide.

7. The lamp of claim 6, wherein the polyetherimide has a weight average molecular weight of from 20,000-60,000.

8. The lamp of claim 6, wherein the polyetherimide has a glass transition temperature of from about 200° C. to about 280° C.

9. The lamp of claim 6, wherein the polyetherimide comprises less than 5 mole percent sulfone linkages.

10. The lamp of claim 1, wherein the visible light transmission in the range of 500-700 nm is at least about 70%.

11. The lamp of claim 1, wherein the visible light transmission in the range of 500-700 nm is at least about 80%.

12. The lamp of claim 1, wherein the film comprises a mixture comprising from 99.99 to 85 wt % polyetherimide and 0.01-15 wt % coumarin-based colorant.

13. The lamp of claim 1, wherein the source of illumination comprises a fluorescent light source.

14. The lamp of claim 1 wherein the film is in the form of a sleeve having an axial length which is at least equal to an axial length of a light emitting portion of the envelope.

15. The lamp of claim 1, wherein the lamp has a lumen loss of less than 15%, as compared with an equivalent lamp formed without the film.

16. The lamp of claim 15, wherein the lamp has a lumen loss of less than 10%, as compared with an equivalent lamp formed without the film.

17. The lamp of claim 1, wherein the polymer matrix and blocking material being stable at lamp operating temperatures of above 150° C.

18. A lamp comprising:
an envelope;
a source of illumination disposed within the envelope; and
a sleeve surrounding the envelope, the sleeve comprising a polymer matrix which includes a polyetherimide as a dominant component and a blocking material dispersed in the polymer matrix, the blocking material comprising a coumarin dye.

19. The lamp of claim 18, wherein the sleeve has a transmission of less than 5% in a range of from 245 to 450 nm.

20. The lamp of claim 19, wherein the sleeve has a transmission of at least 80% in a range of from 500 to 700 nm.

21. A method of forming a lamp comprising:
providing a source of illumination disposed within an envelope; and
disposing a film around the envelope so as to block the transmission of substantially all light emitted from the envelope in the range of 300 to 400 nm and below a selected wavelength in the visible range, the selected wavelength being above about 450 nm, the film transmitting substantially all visible light above the selected wavelength, the film comprising a polymer matrix and a blocking material dispersed in the polymer matrix, the polymer matrix and blocking material being UV stable at lamp operating temperatures of above 100° C.

22. A method of forming the lamp of claim 21, comprising:
providing a source of illumination disposed within an envelope; and
disposing a sleeve around the envelope, the sleeve comprising a polymer matrix which includes polyetherimide as a dominant component and a blocking material dispersed in the polymer matrix, the blocking material comprising a coumarin dye.

23. A method of illuminating an object comprising:
forming the lamp of claim 1;
operating the lamp; and
illuminating the object with light from the lamp wherein less than 1% of light emitted has a wavelength of less than 480 nm.
